(19) United States
(12) Patent Application Publication
(10) Pub. No.: US 2009/0028665 A1
(43) Pub. Date: Jan. 29, 2009

(54) HIGH SCREWING SCREW

(75) Inventor: CHING-HSIANG CHANG, TAINAN COUNTY 711 (TW)

Correspondence Address: ROSENBERG, KLEIN & LEE, 3458 ELLICOTT CENTER DRIVE-SUITE 101, ELLICOTT CITY, MD, 21043, US

(73) Assignee: ESSENCE METHOD REFINE CO., LTD., TAINAN COUNTY 711 (TW)

(21) Appl. No.: 11/836,432

(22) Filed: Aug. 9, 2007

(30) Foreign Application Priority Data
Jul. 27, 2007 (TW) 09620449100

(51) Int. Cl. F16B 25/10

(52) U.S. Cl. 411/387.3; 411/387.8

(57) ABSTRACT

The present invention pertains to a screw notably comprising a shank with a plurality of flat surfaces; wherein, a lip is defined by the junction of any of two adjacent flat surfaces, and a rib located between two threads is protruded from the lip. While in operation, by means of the configuration of the ribs, the screw facilitates to increase the cutting capability for achieving a higher screwing speed and preserve a good resistance of extraction.

### BACKGROUND OF THE INVENTION

1. Field of the Invention

The present invention relates to a screw, in particular a screw with a function of enhancing the capability of cutting, increasing the screwing efficiency and keeping a good resistance of extraction.

2. Description of the Related Art

Referring to FIG. 1, a conventional screw 1 comprises a head 10, a shank 11 extending from the head 10, a plurality of threads 12 disposed helically along the shank 11, and a drilling tip 13 disposed on the end of the shank 11. While in operation, the screw 1 can be screwed into the object 2 through the drilling tip 13 and the threads 12 for cutting the fibers of the object 2.

However, there are still some disadvantages with the conventional screw 1:

### 1. Decreasing the Efficiency of Screwing

The fibers of the object 2 may not be entirely chipped by threads 12, which results in twining itself round the shank 11 and increasing the cutting resistance. As a consequence, the cutting speed would be lowered down, and people need to transfer lots of force upon the screw 1.

### 2. Problem of Extracting Out of the Object

By means of the configuration of the screw 11 it may be facilely removed outwardly to the surface of the objects while in a big impact, such as an earthquake. Thus, the screw 1 has lower resistance of extraction and also lacks of stable screwing capability.

### 3. Not Suitable for Various Objects

The conventional screw 1 could be exerted with the wooden or the metal objects. However, it should also be adjusted depend on different objects while in operation, thus causing the inconvenience.

### SUMMARY OF THE INVENTION

The objects of the present invention are to provide a screw that aids in increasing the screwing efficiency by enhancing the cutting capability and maintaining a good resistance of extraction.

The screw in accordance with the present invention comprises a screw head, a shank extending from the screw head, a plurality of threads disposed helically along the shank; and a drilling portion disposed opposite to the screw head; wherein, the shank consists of a plurality of flat surfaces densely disposed around an outer circumference thereof; a lip is defined between any two flat surfaces, and a rib is protruded upwardly from the lip. By means of the design of the rib, the screw facilitates to increase the cutting capability, which benefits of achieving a higher screwing speed, and preserve a good resistance of extraction.

The advantages of the present invention over the known prior art will become more apparent to those of ordinary skilled in the art upon reading the following descriptions in conjunction with the accompanying drawings.

### BRIEF DESCRIPTION OF THE DRAWINGS

FIG. 1 is a schematic view showing a conventional screw;

FIG. 2 is a perspective view showing a first preferred embodiment of the present invention;

FIG. 3 is a cross sectional schematic view showing a second preferred embodiment of the present invention;

FIG. 4 is a cross sectional schematic view showing the first preferred embodiment of the present invention;

FIG. 5 is a cross sectional schematic view showing a third preferred embodiment of the present invention;

FIG. 6 is a cross sectional schematic view showing a fourth preferred embodiment of the present invention;

FIG. 7 is a cross sectional schematic view showing a fifth preferred embodiment of the present invention

FIG. 8 is a schematic view showing a sixth preferred embodiment of the present invention;

FIG. 9 is a cross sectional schematic view showing the sixth preferred embodiment of the present invention;

FIG. 10 is a cross sectional schematic view showing a seventh preferred embodiment of the present invention;

FIG. 11 is a perspective view showing an eighth preferred embodiment of the present invention;

FIG. 12 is a perspective view showing a ninth preferred embodiment of the present invention;

FIG. 13 is a perspective view showing a tenth preferred embodiment of the present invention;

FIG. 14 is a perspective view showing an eleventh preferred embodiment of the present invention;

FIG. 15 is a perspective view showing a twelfth preferred embodiment of the present invention;

FIG. 16 is a cross sectional schematic view showing the twelfth preferred embodiment of the present invention;

FIG. 17 is a cross sectional schematic view showing a thirteenth preferred embodiment of the present invention; and

FIG. 18 is a cross sectional schematic view showing a fourteenth preferred embodiment of the present invention.

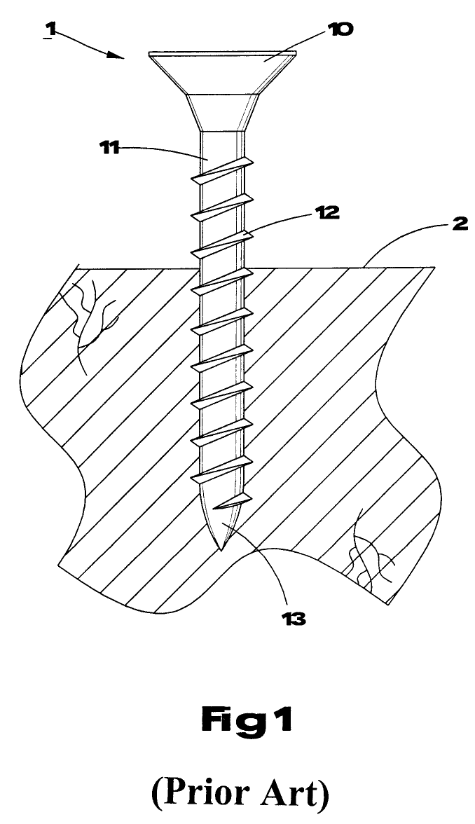

### DETAILED DESCRIPTION OF THE PREFERRED EMBODIMENTS

Before the present invention is described in greater detail, it should be noted that the similar elements are denoted by the same reference numerals throughout the disclosure.

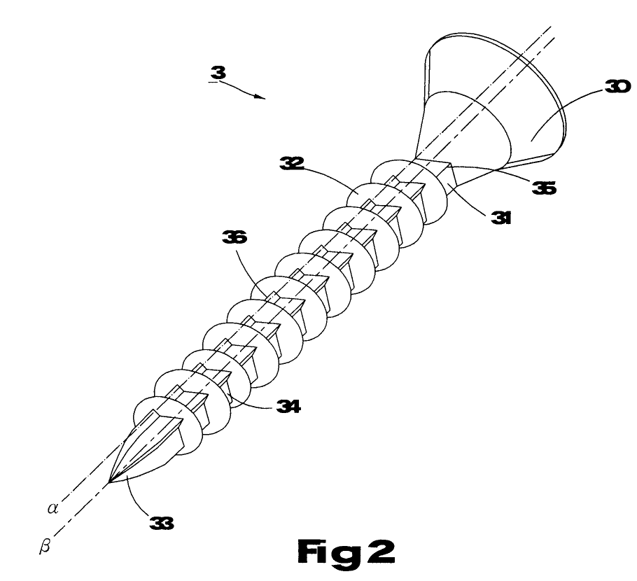

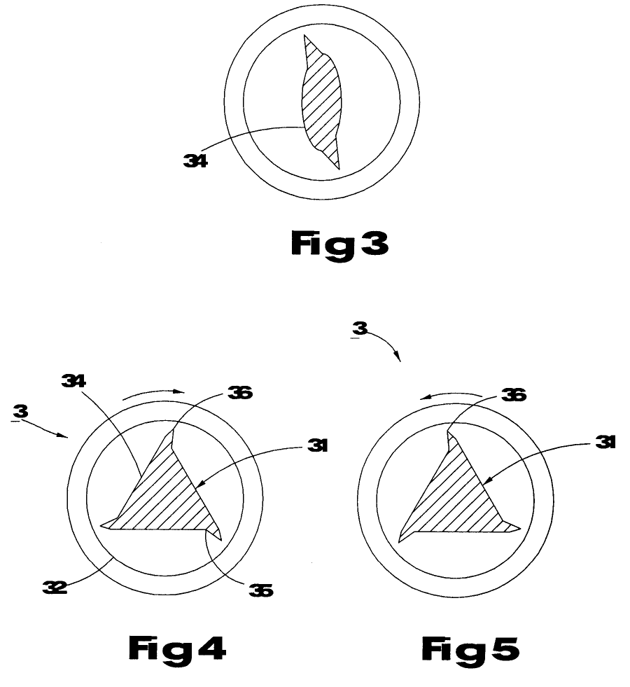

Referring to FIG. 2, a screw 3 of the first preferred embodiment comprises a screw head 30, a shank 31 longitudinally extending from the head 30, a plurality of threads 32 disposed helically along the shank 31, and a drilling portion 33 disposed on a distal end of the shank 31, opposite to the screw head 30; wherein, the shank 31 consists of a plurality of flat surfaces 34 densely disposed around an outer circumference thereof; additionally, the flat surfaces can be joined as a two-side shape shown in FIG. 3, or as a triangular shape shown in FIGS. 4 and 5, and the triangular shape is adopted in the preferred embodiments of the present invention.

Still further, referring to FIG. 2, a lip 35 is defined by the junction of any of two adjacent flat surfaces 34; a linking line “α” is defined by aligning the lip 35 with other lips 35 of flat surfaces 34 and is parallel with respect to the shank axis “β”. In addition, a rib 36 is protruded upwardly from the lip 35 and is located between any two adjacent threads 32; further the outer diameter of threads 32 exceeds the height of the rib 36. The rib 36 is protruded toward the fastening direction as shown in FIG. 4 or toward the loosening direction as shown in FIG. 5; furthermore, the aforesaid ribs 36 arranged in opposite directions are formed in non-equiangular triangle shapes; relatively, the rib 36 can also be inclined with respect to the shank axis “β”, thus forming an equiangular triangle shape as shown in FIG. 6. The type of the ribs 36 as illustrated in FIG. 4 is adopted in the following descriptions.

Referring to FIGS. 2 and 4, while in operation, the shank 31 is rapidly driven into the object by the rib 36 for aiding in cutting the fibers of the object with the drilling portion 33 and for chipping the debris with the threads 32 (not shown in the figures), so as to decrease the drilling resistance and increase the drilling speed. Additionally, the screw 3 is able to be firmly fixed and maintains a good resistance of extraction through the rib 36 after drilling into the object, even if being subjected to the earthquake.

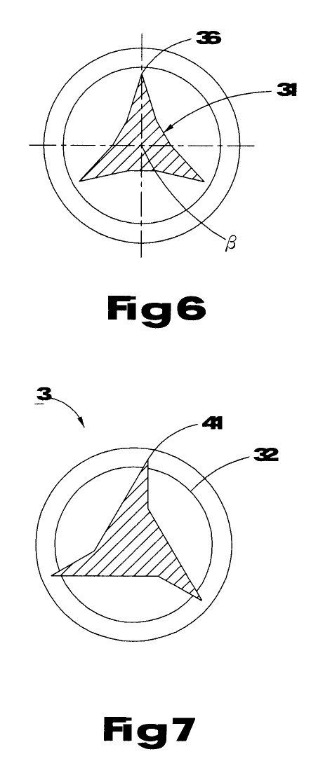

As shown in FIG. 7, a screw 3 of the fifth preferred embodiment of the present invention comprises the similar elements as the first embodiment. Notably, the height of the rib 41 exceeds the outer diameter of the threads 32, which still results in the same operations and the effects as the first preferred embodiment.

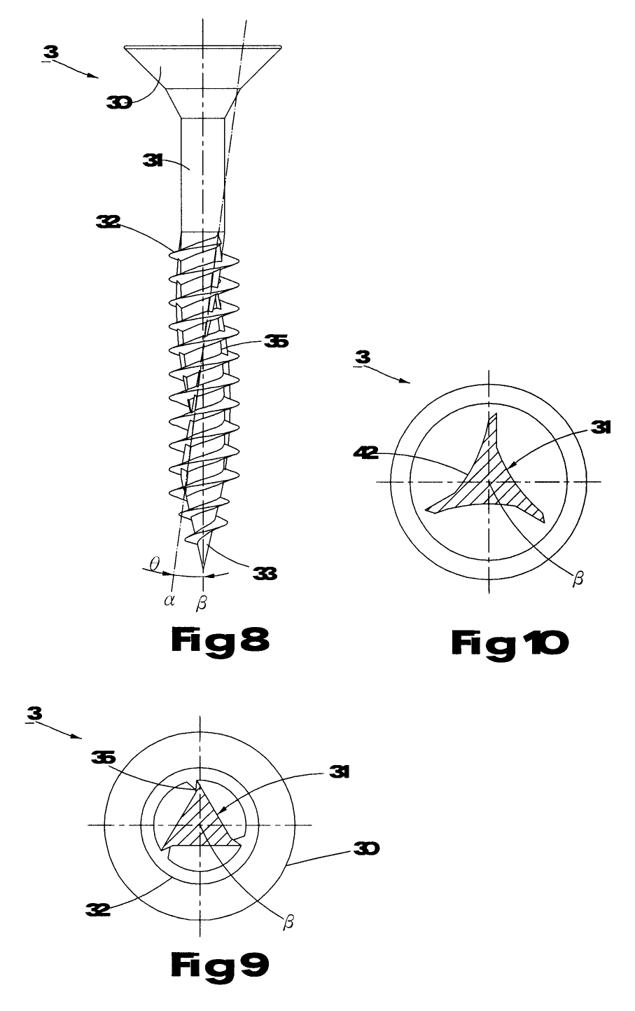

Referring to FIGS. 8 and 9, a screw 3 of the sixth preferred embodiment of the present invention comprises the similar elements, operations, and the effects as the aforementioned preferred embodiments. Characterized in that the linking line “α” is defined by aligning the lip 35 with other lips 35 of the flat surfaces 34 and is inclined with respect to the shank axis “β” by an angle “θ”, thereby increasing the cutting capability and the screwing speed.

Referring to FIG. 10, a screw 3 of the seventh preferred embodiment of the present invention comprises the similar elements, operations, and the effects as the aforementioned preferred embodiments. In particular, at least one of the flat surfaces 42 of the shank 31 is curved in a direction toward the shank axis “β”, whereby the screw 3 is able to be firmly screwed into the metal object with an increased stability. Further, the shank 31 also has a larger space for accommodating the debris from the object, so as to reduce the screwing resistance and prevent from the destruction of the screw 3 and the object. As a result, the screw 3 can be screwed to the wooden and the metal objects with a good screwing capability.

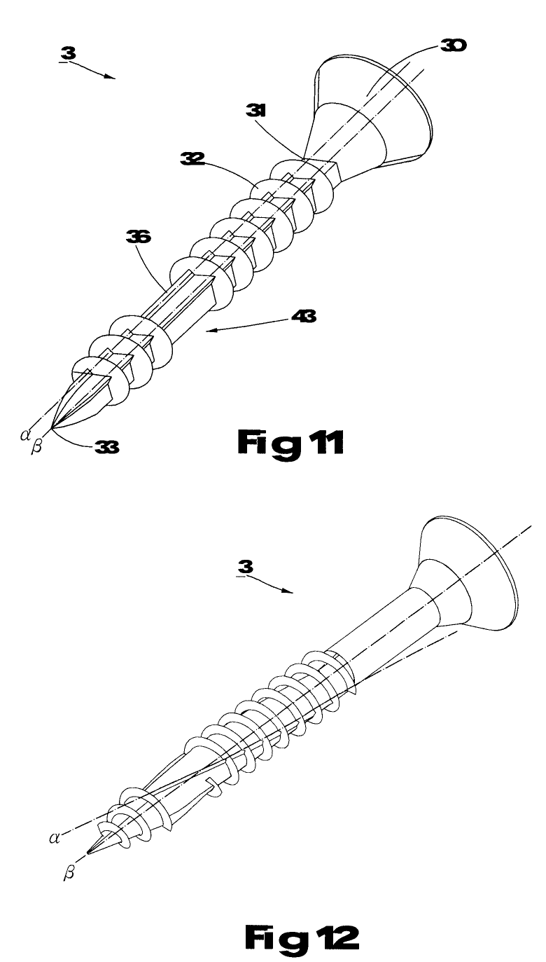

Referring to FIGS. 11 and 12, a screw 3 of the eighth preferred embodiment of the present invention comprises the similar elements, operations, and the effects as the aforementioned preferred embodiments. Differently, a non-threaded area 43 is disposed between the threads 32 for accommodating the debris from the object; simultaneously, the linking line “α” is parallel or is inclined with respect to the shank axis “β” as respectively shown in FIGS. 11 and 12, whereby the rib 36 on the shank 31 benefits of enhancing the cutting capability, so as to increase the screwing stability and maintain a good resistance of extraction.

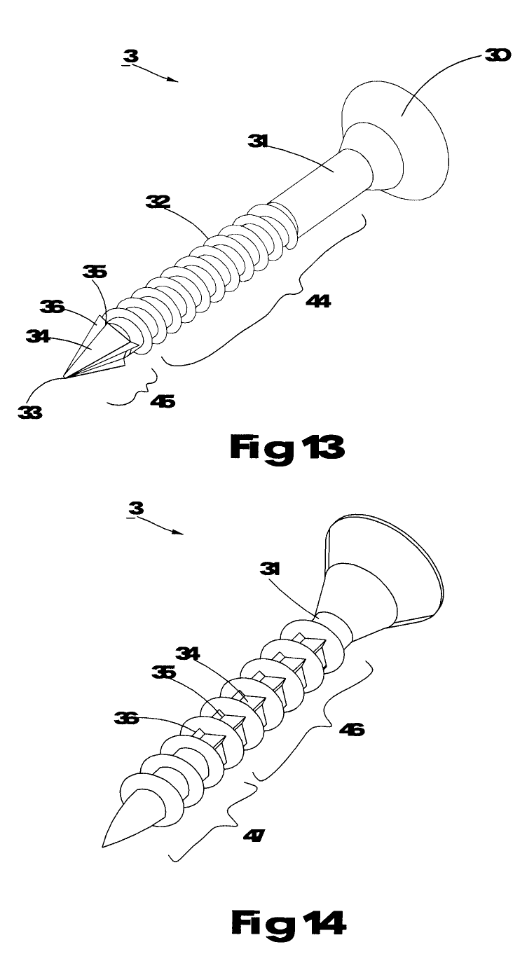

Referring to FIG. 13, a screw 3 of the tenth preferred embodiment of the present invention includes the similar elements, operations, and the effects as the aforementioned preferred embodiments. Characterized in that the shank 31 is divided into a first shank section 44 and a second shank section 45; wherein, the first shank section 44 is formed in a round shape, and the second shank section 45 has a plurality of flat surfaces 34 with the lip 35 defined in the junction of any two adjacent flat surfaces 34, and the rib 36 is protruded from the lip 35. While in operation, the rib 36 of the second shank section 45 is initially drilled into the object, which results in driving the threads 32 of the first shank section 44 to be screwed into the object (not shown in the figure), hence increasing the screwing speed and maintaining a good resistance of extraction.

Referring to FIG. 14, a screw 3 of the eleventh preferred embodiment of the present invention comprises the opposite elements to the tenth preferred embodiment. That is, the second shank section 45 is formed in a round shape, and the first shank section 44 has a plurality of the flat surfaces 34 with the lip 35 defined in the junction of any two adjacent flat surfaces 34, and the 36 is protruded from the lip 35. Although the structure of the eleventh embodiment is different to that of the tenth embodiment, the operation and the effects are the same.

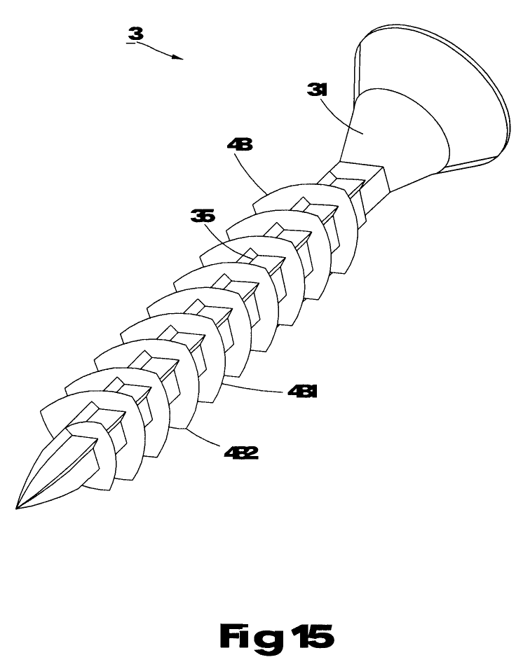

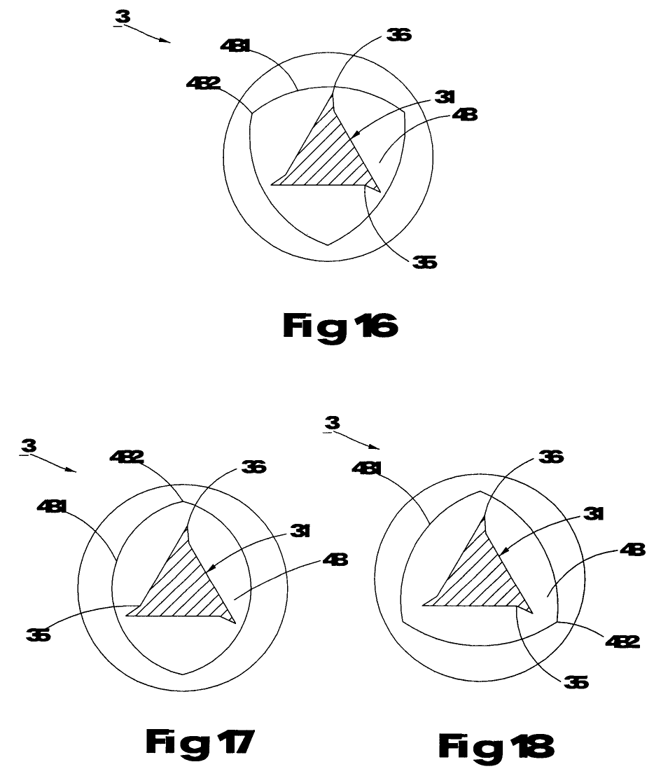

Referring to FIG. 15, a screw 3 of the twelfth preferred embodiment comprises the similar elements as the first preferred embodiment. Notably, the threads 48 have a plurality of cutting edges 481, where a cutting tip 482 is formed by the junction of any two of said adjacent cutting edges, and the threads 48 consists of three cutting edges 481 as shown in FIGS. 15 and 16 or of two cutting edges 481 as shown in FIG. 17. Simultaneously, each of the lips 35 on the shank 31 is arranged opposite to each of the cutting tip 482 or to each of the cutting edges 481, respectively illustrated in FIGS. 16, 17 and 18. Thus, the screw 3 can be rapidly drilled and screwed into the wooden or the metal objects with the increased stability by means of the cutting tips 482 and the rib 36.

To sum up, the present invention takes advantage of the unique configurations of the shank with ribs, and threads for drilling the screw into the various objects. Further, the ribs and the threads facilitate to enhance the cutting capability and preserve a good resistance of extraction, thereby increasing the screwing stability and the screwing efficiency.

While we have shown and described the present invention with reference to the specific preferred embodiment, it should be clear to those skilled in the art that further embodiments may be made without departing from the scope of the present invention.

I claim:

1. A high screwing screw comprising:
a screw head;
a shank longitudinally extending from said screw head;
a plurality of threads disposed helically along said shank; and
a drilling portion disposed on a distal end of said shank, opposite to said screw head;
wherein, said shank consisting of a plurality of flat surfaces densely disposed around an outer circumference thereof; a lip being defined by the junction of any of two said adjacent flat surfaces; a rib being protruded upwardly from said lip and located between any two said adjacent threads.

2. The screw as claimed in claim 1, wherein said rib is formed in a triangular shape.

3. The screw as claimed in claim 1, wherein a linking line is defined by aligning said lip with said other lips of said flat surfaces; said linking line is inclined with respect to a shank axis by an angle.

4. The screw as claimed in claim 1, wherein said linking line is defined by aligning said lip with said other lips of said flat surfaces; said linking line is parallel with respect to said shank axis.

5. The screw as claimed in claim 1, wherein at least one of said flat surfaces is curved in a direction toward said shank axis.

6. The screw as claimed in claim 1, wherein said shank is divided into a first shank section and a second shank section; said first shank section is formed in a round shape; said second shank section consists of a plurality of said flat surfaces with said lip defined in the junction of any of said two adjacent flat surfaces; said rib is protruded from said lip.

7. The screw as claimed in claim 1, wherein said shank is divided into a first shank section and a second shank section; said first shank section consists of a plurality of said flat surfaces with said lip defined in the junction of any of said two adjacent flat surfaces; said second shank section is formed in a round shape.

8. The screw as claimed in claim 6, wherein said second shank section is arranged without said threads disposed thereon

9. The screw as claimed in claim 1, wherein a non-threaded area is disposed between said threads.

10. The screw as claimed in claim 1, wherein said threads comprises a plurality of cutting edges, where a cutting tip is formed by a junction of any of two said cutting edges.

11. The screw as claimed in claim 10, wherein each of said lips on said shank is arranged opposite to each of said cutting tips.

12. The screw as claimed in claim 10, wherein each of said lips on said shank is arranged opposite to each of said cutting edges.
